(19) United States
(12) Patent Application Publication
(10) Pub. No.: US 2012/0257861 A1
(43) Pub. Date: Oct. 11, 2012

(54) Optical Fiber Communication Device

(75) Inventors: Ya-Chi Kang, New Taipei City (TW); Hsueh-Hui Chiu, New Taipei City (TW); Ching-Feng Hsieh, Taipei (TW)

(73) Assignee: Askey Computer Corporation, New Taipei City (TW)

(21) Appl. No.: 13/150,845

(22) Filed: Jun. 1, 2011

(30) Foreign Application Priority Data
Apr. 8, 2011 (TW) 100206160

(51) Int. Cl. G02B 6/36

(52) U.S. Cl. 385/91

(57) ABSTRACT

An optical fiber communication device is applicable to positioning an optical fiber cable having a first optical fiber connector. The optical fiber communication device includes a main body and a positioning slot. The main body has a case and a second optical fiber connector for the first optical fiber connector to be inserted therein. The positioning slot is disposed continuously around the periphery of the case of the main body in an outwardly open manner, thereby providing a space for the optical fiber cable to be received therein, and positioning the optical fiber cable. The optical fiber communication device winds up the optical fiber cable around the main body through the positioning slot, without assembling/disassembling a coiling drum, thereby efficiently simplifying the process of positioning the optical fiber cable in the optical fiber communication device.

### BACKGROUND OF THE INVENTION

1. Field of the Invention

This invention relates to optical fiber communication devices, more particularly, to an optical fiber communication device that positions an optical fiber cable having a first optical fiber connector

2. Description of Related Art

An optical fiber cable has usage lifetime far longer than a traditional copper cable. The optical fiber cable also has much lower production and maintenance cost, as compared with the copper cable. Consequently, the optical fiber network technologies using the optical fiber cable as the signal transmission medium have become the communication means being developed by the modem wideband industry. Presently, the optical fiber network technologies mostly attracting the industry are using a single optical fiber cable to provide the passive optical fiber network (PON) network bi-direction data transmission. In accordance with the demand of high speed data transmission, the PON has been advanced into the generation of Gigabit-capable PON (GPON), the GPON can transmit data at a higher speed up to 2 Gbps and be applicable to Ethernet and other networks.

Consequently, the industry has designed the optical fiber communication devices specifically applicable to the GPON. An optical fiber communication device has to connect with a basic peripheral equipment of the optical fiber network system terminal through an optical fiber cable equipped therewith, and thus installs the optical fiber network to the end user and achieving the purpose of optical fiber service. The optical fiber cable equipped in the optical fiber communication device usually has some extra length for adjusting to various installing background. A coiling drum is disposed on the bottom base or upper cover of the optical fiber communication device for coiling up the remaining unused optical fiber cable after installing, thereby avoiding an unpleasant appearance caused by the untidy leftover cable, also preventing from losing signal transmission energy and damage due to the bend radius of the optical fiber cable becoming overlarge.

Please refer to FIG. 1, which is an analytical diagram depicting an optical fiber communication device 1 disposed with a coiling drum. The optical fiber communication device 1 comprises an upper cover 11, a bottom base 12, a coiling drum 13, and an optical fiber cable 14. The coiling drum 13 is integrated with the bottom base 12 through a spindle axe 131. The coiling drum 13 has a plurality of opposing hooks 132 disposed at a specific interval for winding up and positioning the optical fiber cable 14 in the coiling drum 13, thereby tidying up the optical fiber cable 14.

However, when a user uses the coiling drum 13 for tidying up the optical fiber cable 14, the user must first disintegrate the coiling drum 13 and the bottom base 12 to expose the hooks 132, and then wind up the optical fiber cable around the hooks 132. The coiling drum 13 and the bottom base 12 then has to be bound together to hide the hooks 132 and the coiled optical fiber cable 14. Accordingly, it is a long and complicated procedure for tidying up the optical fiber cable and causing inconveniences to the user.

Hence, it is a highly urgent technique issue in the industry how to simplify the procedure of tidying up and positioning an optical fiber cable in a optical fiber communication device.

### SUMMARY OF THE INVENTION

In view of the drawbacks of the prior art mentioned above, it is therefore an objective of this invention to provide an optical fiber communication device that is capable of simplifying the procedure of positioning an optical fiber cable in the optical fiber communication device.

To achieve the aforementioned and other objective, the present invention discloses an optical fiber communication device, which is applicable to positioning an optical fiber cable having a first optical fiber connector, comprising: a main body having a case and a second optical fiber connector for the first optical fiber connector to be inserted therein; and a positioning slot formed continuously around a periphery of the case of the main body in an outwardly open manner, thereby providing a space for the optical fiber cable to be received therein, and positioning the optical fiber cable.

In an embodiment of the present invention, the positioning slot has a bending angle surrounding the case of the main body that has a bending radius ranging from 25 to 35 millimeters, and the optical fiber communication device further comprises a blocker disposed on the main body for blocking the optical fiber cable received in the positioning slot.

In another embodiment of the present invention, the optical fiber communication device further comprises a shield element inserted in the case of the main body, for shielding the positioning slot and the optical fiber cable exposed from the positioning slot; the shield element is a rubber band or plastic band; the optical fiber communication device further comprises an Ethernet connector; the case of the main body comprises a bottom base and an upper cover, the upper cover having an opening for exposing the second optical fiber connector and a portion of the bottom base adjoining the second optical fiber connector; the positioning slot is allocated on the bottom base or the upper cover; the optical fiber communication device further comprises an auxiliary cover for covering the opening of the upper cover and thus shielding the second optical fiber connector; a first hook element is disposed on a portion of the bottom base exposed from the opening, and the auxiliary cover has a second hook element for engaging with the first hook element.

In summary, the optical fiber communication device of the present invention is applicable to positioning an optical fiber cable having a first optical fiber connector. The optical fiber communication device comprises a main body and a positioning slot. The main body further comprises a case and a second optical fiber connector for the first optical fiber connector to be inserted therein, and the positioning slot is disposed continuously around a periphery of the case of the main body in an outwardly open manner, thereby providing a space for the optical fiber cable to be received therein and positioning the optical fiber cable. Compared with the prior art, the optical fiber communication device of the present invention directly winds up the optical fiber cable around the main body using the positioning slot, without assembling/disassembling a coiling drum, thereby simplifying the process of positioning the optical fiber cable in the optical fiber communication device.

### BRIEF DESCRIPTION OF DRAWINGS

The invention can be more fully understood by reading the following detailed description of the preferred embodiments, with reference made to the accompanying drawings, wherein:

FIG. 1 is an analytical diagram depicting an optical fiber communication device disposed with a coiling drum according to the prior art;

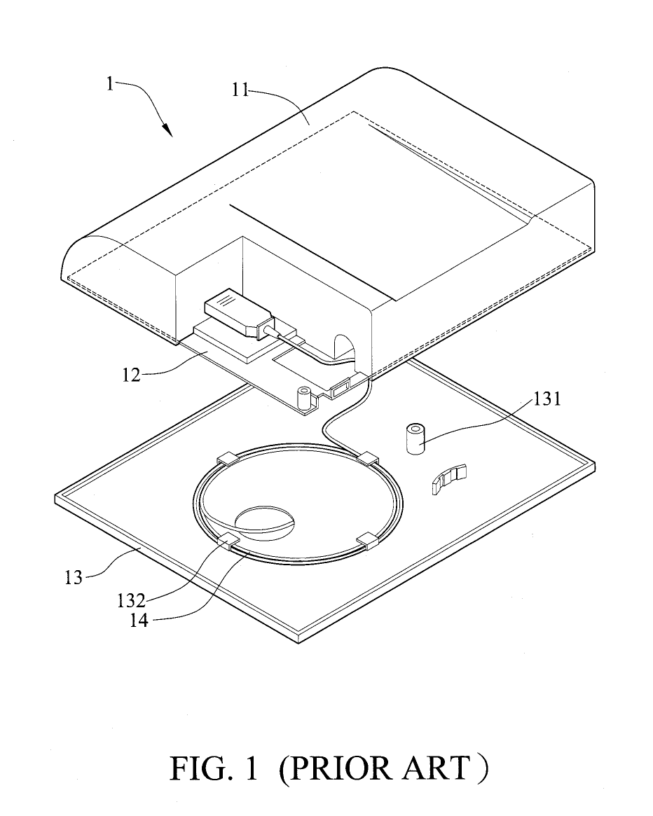

FIG. 2 is a 3-D diagram depicting a first embodiment of an optical fiber communication device according to the present invention;

FIG. 3 is a schematic diagram depicting the optical fiber communication devices of the present invention connecting to an optical fiber network system terminal and user terminals;

FIG. 4 is an exploded diagram depicting a second embodiment of an optical fiber communication device according to the present invention;

FIG. 5 is a sectional diagram depicting the optical fiber communication device of FIG. 4; and

FIG. 6 is a 3-D diagram depicting a third embodiment of an optical fiber communication device according to the present invention.

### DETAILED DESCRIPTION OF PREFERRED EMBODIMENTS

The following illustrative embodiments are provided to illustrate the disclosure of the present invention; those in the art can apparently understand these and other advantages and effects after reading the disclosure of this specification. The present invention can also be performed or applied by other different embodiments. The details of the specification may be on the basis of different points and applications, and numerous modifications and variations can be devised without departing from the spirit of the present invention.

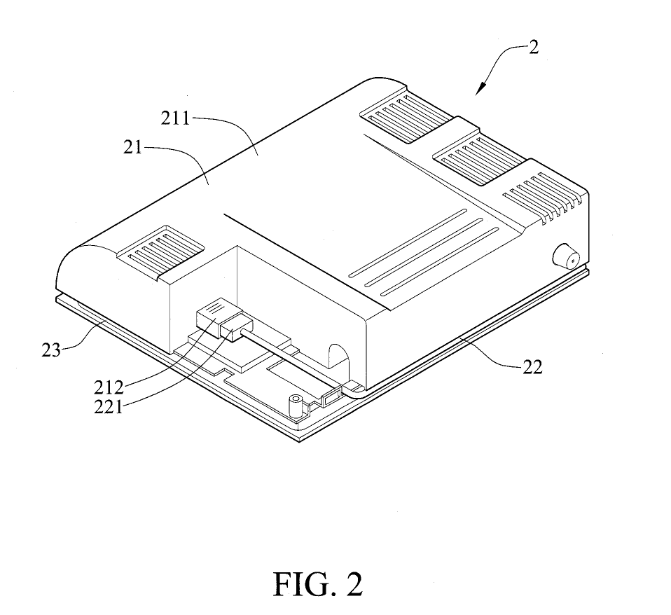

An optical fiber communication device according to the present invention is a basic equipment applicable to connect with an optical fiber network system terminal for achieving the goal of optical fiber service. Please refer to FIG. 2, which is a 3-D diagram depicting a first embodiment of an optical fiber communication device 2 according to the present invention. The optical fiber communication device 2 may position an optical fiber cable 22 having a first optical fiber connector 221. The optical fiber communication device 2 comprises a main body 21 and a positioning slot 23. The main body 21 comprises a case 211 for covering circuits (not shown) that are embedded with a passive optical fiber network applicable to a gigabit-cable PON (GPON) to be received therein, and a second optical fiber connector 212 for inputting/outputting optical signals. The positioning slot 23 is formed continuously around the case 211 of the main body 21 in an outwardly open manner, thereby providing a space for the optical fiber cable 22 to be received therein. Therefore, the optical fiber cable 22 may be positioned around the periphery of the main body 21, so as to achieve the goal of tidying up the optical fiber cable 22.

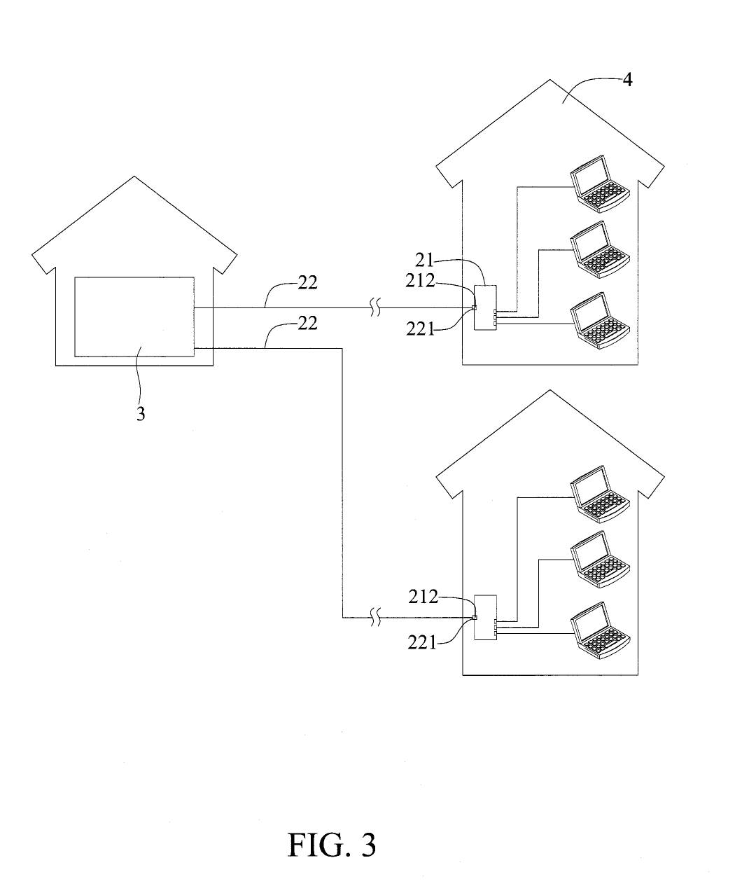

Please further refer to FIG. 3, which is a schematic diagram depicting an optical fiber communication device that connects an optical fiber network system terminal 3 with a user terminal 4 according to the present invention. One end of the optical fiber cable 22 that has the first optical fiber connector 221 is inserted into the second optical fiber connector 212 of the main body 21, and the other end of the optical fiber cable 22 is connected to a basic equipment of the optical fiber network system terminal 3. The user terminal 4 is able to communicate optical signals bi-directionally with the optical fiber network system terminal 3 via the optical fiber cable 22. An optical fiber network may be thus installed from the optical fiber network system terminal 3 to the user terminal 4.

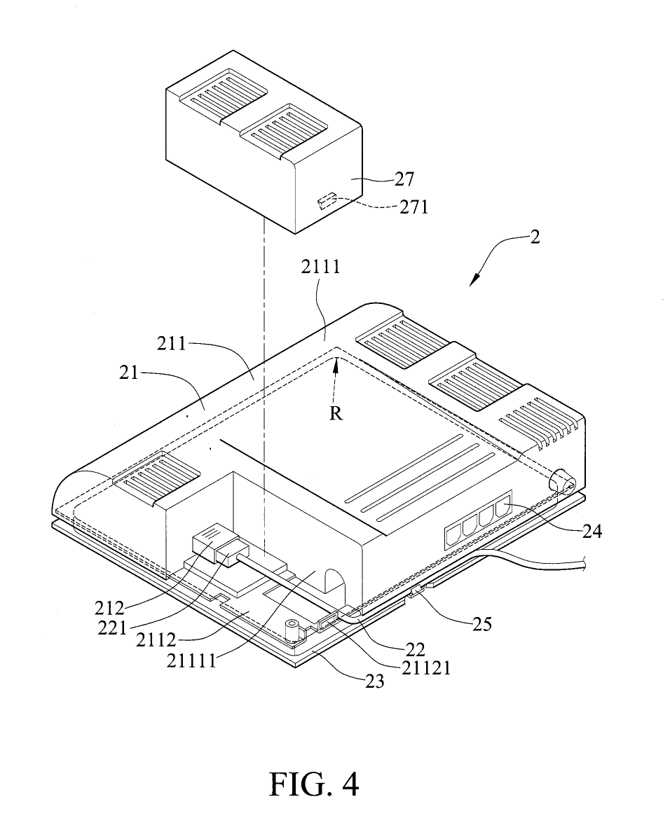

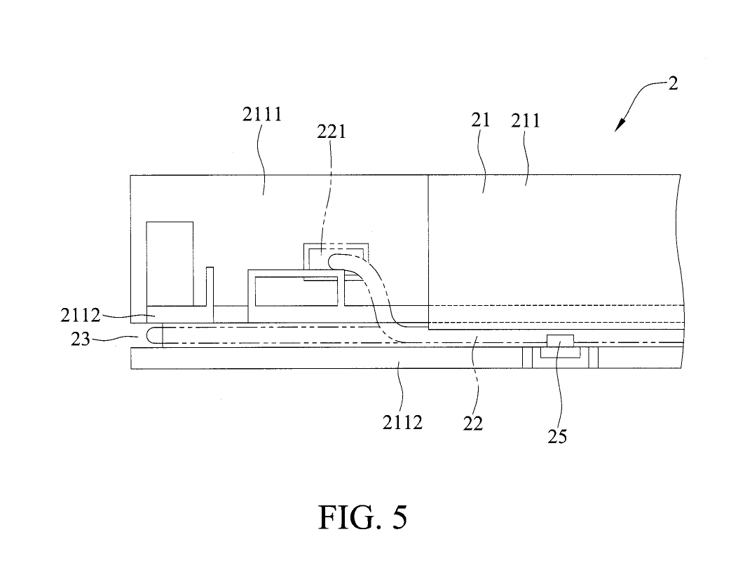

Please refer to FIGS. 4 and 5, which are exploded and sectional diagrams of an optical fiber communication device of a second embodiment according to the present invention, respectively. In order to clearly and better understand features and advantages of the second embodiment, the structures and functions different from the first embodiment are shown and described only, and the same or similar elements are labeled with the same or similar symbols as in the first embodiment.

The optical fiber communication device 2 comprises a main body 21, a positioning slot 23, and an Ethernet connector 24. With the Ethernet connector 24, the optical fiber communication device 2 may transmit signals according to the Ethernet protocol. In accordance with demands of the user terminal, the optical fiber communication device 2 may be further equipped with connectors having other signal transmission specifications, such as T1, ATM, and audio/video connectors. Furthermore, the case 211 of the main body 21 comprises an upper cover 2111 and a bottom base 2112 locked with the upper cover 2111 for protecting the circuits installed therein.

In the second embodiment, the upper cover 2111 has an opening 21111 for exposing the second optical fiber connector 212 and a portion of the bottom base 2112 adjoining the second optical fiber connector 212, providing the user with convenience to insert the optical fiber cable 22. Accordingly, the user may drag the optical fiber cable 22 along the exposed portion of the bottom base 2112 to the positioning slot 23. A first hook element 21121 is disposed on the portion of the bottom base 2112 exposed from the opening 21111. The optical fiber communication device 2 has an auxiliary cover 27 that has a second hook element 271 for engaging with the first hook element 21121. Through the engagement of the hook elements 21121 and 271, the auxiliary cover 27 may cover the opening 21111 of the upper cover 2111, and shield the second optical fiber connector 212 and the portion of the bottom base 2112 exposed from the opening 21111. Moreover, the optical fiber communication device 2 has an improved appearance.

In the second embodiment, the optical fiber communication device 2 is equipped with a blocker 25 disposed at a position on the main body 211 close to the positioning slot 23, for blocking the optical fiber cable 22 received in the positioning slot 23. The blocker 25 has a downward increasing cross section, and thus may withstand bending and cutting forces and protect the optical fiber cable 22 from being depressed and broken. The blocker 25 may have a shape that is adjusted in accordance with the optical fiber cable 22. For example, the blocker 25 can be in the shape of a hook, and blocks the optical fiber cable 22 in the positioning slot 23 steadily.

Preferably, the positioning slot 23 may have a bending radius R surrounding a corner of the case 211 of the main body 21 that ranges from 25 to 35 millimeters, in order to prevent the optical signals transmitted over the optical fiber cable 22 from being attenuated and protected the optical fiber cable 22 from being damaged due to too much the bending radius. Note that that the bending radius R may be adjusted in accordance with the diameter of the optical fiber cable 22.

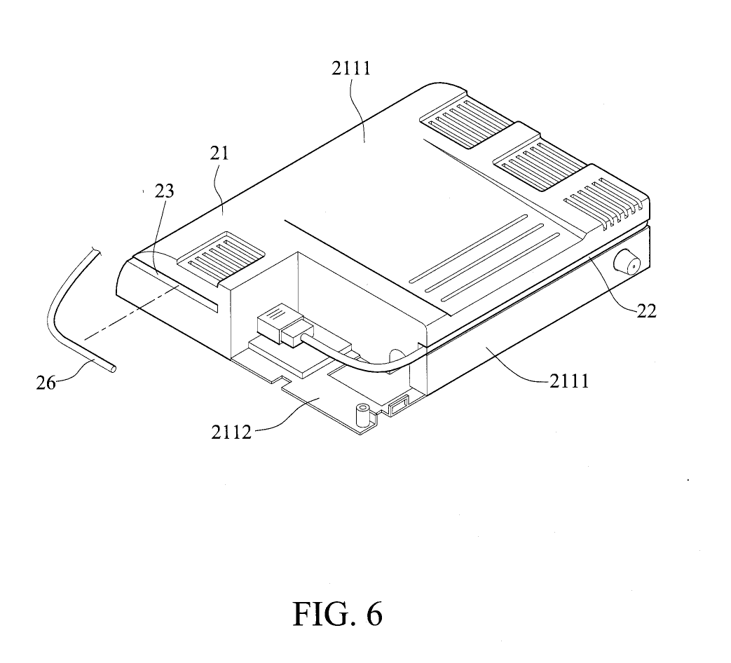

Please refer to FIG. 6, which is a 3-D diagram depicting an optical fiber communication device of a third embodiment according to the present invention. In order to clearly and better understand features and advantages of the third embodiment, followed are description of structure and functions different from the previous embodiments only, the same or similar elements are labeled with the same or similar symbols as in the previous embodiments.

As shown in FIG. 6, the case 211 of optical fiber communication device 2 in the third embodiment comprises an upper cover 2111 and a bottom base 2112. The positioning slot 23 is disposed on a periphery of the upper cover 2111, thereby enabling the optical fiber cable 22 to wind up continuously around the periphery of the upper cover 2111 and efficiently using the upper cover 2111. The optical fiber communication device 2 is also equipped with a shield element 26 such as a rubber band, and with the flexibility feature of the rubber band, inserting the shield element 26 in the case 211 for shielding the positioning slot 23 and the optical fiber cable 22 exposed from the positioning slot 23, and thus enhancing the product appearance of the optical fiber communication device 2 as well as preventing dust from entering into the positioning slot 23. However, the shield element 26 can be designed as a plastic band with hook structure, and then disposing the shield element 26 on the case 211 via the said hook structure.

It should also be noted here that, since the positioning slot 23 of the third embodiment is disposed on the upper cover 2111, the shield element 26 is preferably inserted in the upper cover 2111 whereon the positioning slot 23 is disposed, thereby efficiently shielding the positioning slot 23 and the optical fiber cable 22 exposed from the positioning slot 23. Accordingly, when the positioning slot 23 is disposed on the bottom base 2112, as disclosed in the second embodiment, the shield element 26 is preferably inserted in the bottom base 2112 whereon the positioning slot is disposed.

In summary, the optical fiber communication device of the present invention is applicable to positioning an optical fiber cable having a first optical fiber connector. The optical fiber communication device comprises a main body and a positioning slot. The main body further comprises a case and a second optical fiber connector for the first optical fiber connector to be inserted therein, and the positioning slot is disposed continuously around a periphery of the case of the main body in an outwardly open manner, thereby providing a space for the optical fiber cable to be received therein and positioning the optical fiber cable. Compared with the prior art, the optical fiber communication device of the present invention directly winds up the optical fiber cable around the main body using the positioning slot, without assembling/disassembling a coiling drum, thereby simplifying the process of positioning the optical fiber cable in the optical fiber communication device.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An optical fiber communication device applicable to positioning an optical fiber cable having a first optical fiber connector, comprising:
a main body comprising a case and a second optical fiber connector for the first optical fiber connector to be inserted therein; and
a positioning slot formed continuously around the case of the main body in an outwardly open manner, thereby providing a space for the optical fiber cable to be received therein, and positioning the optical fiber cable.

2. The optical fiber communication device of claim 1, wherein the positioning slot has a corner surrounding the case of the main body that has a bending radius ranging from 25 to 35 millimeters.

3. The optical fiber communication device of claim 2, further comprising a blocker disposed on the main body for blocking the optical fiber cable received in the positioning slot.

4. The optical fiber communication device of claim 1, further comprising a shield element inserted in the case of the main body for shielding the positioning slot and the optical fiber cable exposed from the positioning slot.

5. The optical fiber communication device of claim 4, wherein the shield element is a rubber band or a plastic bend.

6. The optical fiber communication device of claim 1, further comprising an Ethernet connector.

7. The optical fiber communication device of claim 1, wherein the case of the main body comprises an upper cover and a bottom base, the upper cover having an opening for exposing the second optical fiber connector and a portion of the bottom base adjoining the second optical fiber connector, the positioning slot being allocated on the bottom base or the upper cover.

8. The optical fiber communication device of claim 7, further comprising an auxiliary cover that covers the opening of the upper cover for shielding the second optical fiber connector.

9. The optical fiber communication device of claim 8, further comprising a first hook element disposed on the bottom base exposed from the opening, wherein the auxiliary cover has a second hook element for engaging with the first hook element.
